(19) United States
(12) Patent Application Publication
(10) Pub. No.: US 2025/0298129 A1
(43) Pub. Date: Sep. 25, 2025

(54) DISTANCE MEASUREMENT DEVICE AND NON-TRANSITORY COMPUTER READABLE MEDIUM

(71) Applicant: FUJIFILM Business Innovation Corp., Tokyo (JP)

(72) Inventor: Daisuke IGUCHI, Kanagawa (JP)

(73) Assignee: FUJIFILM Business Innovation Corp., Tokyo (JP)

(21) Appl. No.: 18/771,512

(22) Filed: Jul. 12, 2024

(30) Foreign Application Priority Data
Mar. 25, 2024 (JP) 2024-048714

(51) Int. Cl. G01S 7/4863; G01S 7/48; G01S 7/4865; G01S 17/46; G01S 17/89

(52) U.S. Cl. CPC G01S 7/4863; G01S 7/4808; G01S 7/4865; G01S 17/46; G01S 17/89

(57) ABSTRACT

A distance measurement device includes: a light source configured to irradiate a measurement target with pulsed light; a pixel circuit that includes a photoelectric conversion region in which light that is the pulsed light reflected from the measurement target, is converted into charge and a plurality of charge accumulation regions in which the charge converted in the photoelectric conversion region is accumulated; a signal detection unit configured to read, as a plurality of detection signals, signals corresponding to amounts of the charge accumulated in the plurality of respective charge accumulation regions; and a processor configured to control the light source, the pixel circuit, and the signal detection unit and calculate a distance using the plurality of detection signals. The processor is configured to: perform measurement in which the light source generates the pulsed light and charge accumulation processing is executed for a plurality of subframes each being a unit for performing the charge accumulation processing for sequentially accumulating charge in the plurality of charge accumulation regions within a set duration, and the signal detection unit acquires amounts of the charges accumulated in the plurality of charge accumulation regions as the plurality of detection signals for the pulsed light; execute identification processing of identifying a subframe in which a signal, of the plurality of detection signals, corresponding to the pulsed light is generated; and calculate a distance to the measurement target using a result of the identification processing and a phase of the signal, of the plurality of detection signals, corresponding to the pulsed light.

### CROSS-REFERENCE TO RELATED APPLICATIONS

This application is based on and claims priority under 35 USC 119 from Japanese Patent Application No. 2024-048714 filed Mar. 25, 2024.

### BACKGROUND

### (i) Technical Field

The present disclosure relates to a distance measurement device and a non-transitory computer readable medium.

### (ii) Related Art

Japanese Patent No. 7194443 describes a distance image measurement device capable of generating an image signal with improved distance resolution for objects in various distance measurement ranges, by using a sensor device that generates an image signal including distance information based on the time of flight (TOF) of light.

### SUMMARY

In a distance measurement device using an iTOF (indirect time of flight) method and having a plurality of charge accumulation regions for each pixel, a subframe-based system has been proposed in which one frame is divided into a plurality of subframes, and detection of different measurement time regions are performed for the respective subframes in order to widen a distance measurement range while maintaining distance measurement accuracy.

With a subframe-based system of related art, detection signals are acquired from a plurality of charge accumulation regions for each of the subframes. In order to increase the accumulated charge amount detected in a subframe corresponding to a far distance measurement range, the number of frames for the charge accumulation processing is set to be larger for a subframe corresponding to a farther distance measurement range.

Thus, with the subframe-based system of related art, signals between charge accumulation regions across subframes involve a difference in detection timing and detection signal level, resulting in a problem in that an error occurs in the measurement result when phase calculation for acquiring the TOF is performed between the charge accumulation regions across subframes.

Aspects of non-limiting embodiments of the present disclosure relate to a distance measurement device and a program that prevent an error from occurring in a measurement result even when phase calculation is performed between charge accumulation regions across subframes.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a distance measurement device comprising:
a light source configured to irradiate a measurement target with pulsed light;
a pixel circuit that includes a photoelectric conversion region in which light that is the pulsed light reflected from the measurement target, is converted into charge and a plurality of charge accumulation regions in which the charge converted in the photoelectric conversion region is accumulated;
a signal detection unit configured to read, as a plurality of detection signals, signals corresponding to amounts of the charge accumulated in the plurality of respective charge accumulation regions; and
a processor configured to:
   control the light source, the pixel circuit, and the signal detection unit and calculate a distance using the plurality of detection signals, wherein
the processor is configured to:
   perform measurement in which the light source generates the pulsed light and charge accumulation processing is executed for a plurality of subframes each being a unit for performing the charge accumulation processing for sequentially accumulating charge in the plurality of charge accumulation regions within a set duration, and the signal detection unit acquires amounts of the charges accumulated in the plurality of charge accumulation regions as the plurality of detection signals for the pulsed light;
   execute identification processing of identifying a subframe in which a signal, of the plurality of detection signals, corresponding to the pulsed light is generated; and
   calculate a distance to the measurement target using a result of the identification processing and a phase of the signal, of the plurality of detection signals, corresponding to the pulsed light.

### BRIEF DESCRIPTION OF THE DRAWINGS

Exemplary embodiments of the present disclosure will be described in detail based on the following figures, wherein:

FIG. 1 is a diagram illustrating a system configuration of a distance measurement device according to an exemplary embodiment of the present disclosure;

FIG. 2 is a diagram illustrating a distance measurement device of a multi-tap/subframe-based system of Comparative Example;

FIG. 3 is a diagram illustrating distance calculation processing in the distance measurement device of a multi-tap/subframe-based system of Comparative Example;

FIG. 4 is a diagram illustrating distance calculation processing in the distance measurement device according to the exemplary embodiment;

FIG. 5 is a diagram illustrating the distance calculation processing in the distance measurement device according to the exemplary embodiment;

FIG. 6 is a diagram illustrating the distance calculation processing in the distance measurement device according to the exemplary embodiment; and

FIGS. 7A to 7C are diagrams illustrating a combination pattern of results of two phase calculations in a case of performing two measurements different from each other in duration during which charge is accumulated without multipath light.

### DETAILED DESCRIPTION

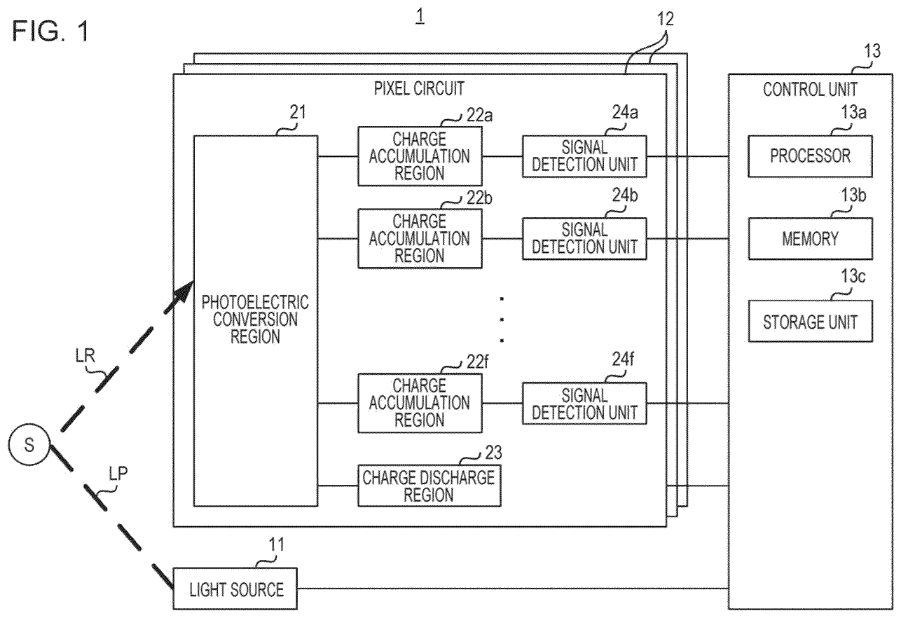

Exemplary embodiments for implementing the technique of the present disclosure will be described below in detail with reference to the drawings. FIG. 1 is a diagram illustrating a system configuration of a distance measurement device 1 according to an exemplary embodiment.

The distance measurement device 1 of the present exemplary embodiment is a device that generates a distance image including distance information for each pixel using an indirect time of flight (iTOF) method, and includes a light source 11, a plurality of pixel circuits 12, and a control unit 13, as illustrated in FIG. 1.

The light source 11 irradiates a measurement target S with pulsed light LP in order to perform distance measurement by the iTOF method. The light source 11 includes, for example, a semiconductor light emitting element such as a light emitting diode or a laser diode, and a drive circuit for driving the semiconductor light emitting element. As the light source 11, an element that generates light in a wavelength region such as a near-infrared region or a visible light region can be used.

The plurality of pixel circuits 12 are arranged in a two dimensional array in two dimensional directions (for example, a column direction and a row direction) to form an image sensor, and photoelectrically convert incident pulsed light LR generated as a result of reflection of the pulsed light LP from the measurement target S, to generate a detection signal.

The pixel circuit 12 is formed by a semiconductor element and includes a photoelectric conversion region 21, first to sixth charge accumulation regions 22a to 22f, a charge discharge region 23, and first to sixth signal detection units 24a to 24f.

The photoelectric conversion region 21 has the function of converting, into charge, the incident pulsed light LR that is light as a result of the reflection of the pulsed light LP on the measurement target S.

The first to sixth charge accumulation regions 22a to 22f are provided close to the photoelectric conversion region 21 while being separated from each other, and have a function of accumulating the charge converted in the photoelectric conversion region 21.

The charge discharge region 23 is a region for discharging the charge generated in the photoelectric conversion region 21 to the outside of the pixel circuit 12.

The first to sixth signal detection units 24a to 24f read signals corresponding to the amounts of charge respectively accumulated in the first to sixth charge accumulation regions 22a to 22f, as first to sixth detection signals, and output the signals to the control unit 13. The first to sixth signal detection units 24a to 24f are formed by, for example, amplifiers including source follower amplifiers and the like.

Note that one charge accumulation region may be referred to as a tap. The pixel circuit 12 of the present exemplary embodiment includes the six charge accumulation regions, which are the first to sixth charge accumulation regions 22a to 22f, and thus has a 6-tap configuration. The number of taps of the pixel circuit 12 is not limited to six, and any configuration may be adopted as long as the number of taps is more than one, that is, for example, four, eight, or the like.

The control unit 13 has functions of controlling the light source 11 and the plurality of pixel circuits 12 including the first to sixth signal detection units 24a to 24f, and calculating the distance from the distance measurement device 1 to the measurement target S using the first to sixth detection signals for each pixel.

The control unit 13 includes a processor 13a, a memory 13b, and a storage unit 13c. The processor 13a executes predetermined processing based on a control program stored in the memory 13b. The storage unit 13c includes, for example, a read only memory (ROM), a hard disk drive (HDD), a solid state drive (SSD), or the like and stores software and data required.

Next, distance calculation processing in the distance measurement device 1 of the present exemplary embodiment will be described.

The distance measurement device 1 of the present exemplary embodiment is a distance measurement device of a multi-tap/subframe-based system in which, in order to widen a distance measurement range while maintaining distance measurement accuracy in a distance measurement device using the iTOF method, one frame is divided into a plurality of subframes by using the multi-tap pixel circuits 12, and detection in different measurement time regions is performed for the respective subframes.

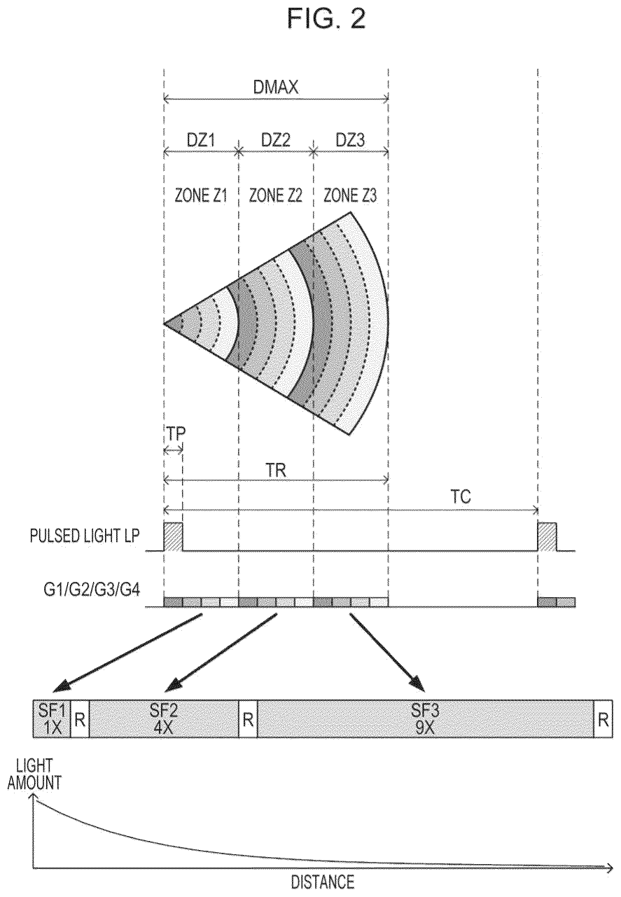

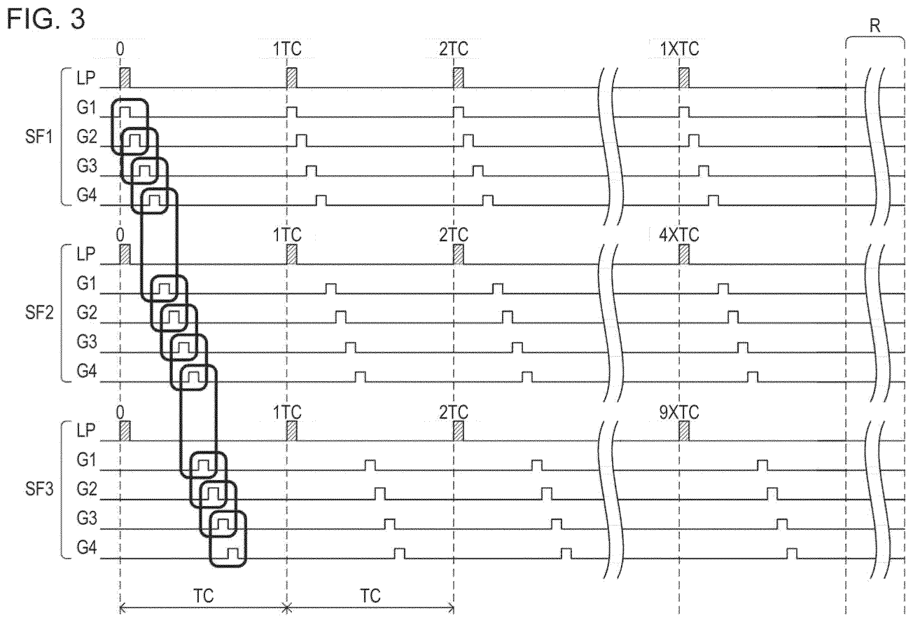

Now, in order to describe the distance measurement device of the multi-tap/subframe-based system, a distance measurement device of a multi-tap/subframe-based system of Comparative Example will be described. FIG. 2 is a diagram illustrating the distance measurement device of a multi-tap/subframe-based system of Comparative Example. FIG. 3 is a diagram illustrating distance calculation processing in the distance measurement device of a multi-tap/subframe-based system of Comparative Example.

For the sake of simplifying the explanation, the distance measurement device of Comparative Example will be described using a distance measurement device of a 4-tap/3-subframe-based system as an example.

As illustrated in FIG. 2, in the distance measurement device of a 4-tap/3-subframe-based system, a 4-tap pixel circuit including four charge accumulation regions is used, the distance measurement range is divided into three zones Z1 to Z3, one frame is correspondingly divided into three subframes SF1 to SF3, and four detection signals are acquired from the four charge accumulation regions for each subframe.

In FIG. 2, G1/G2/G3/G4 indicate detection timings in each of the four charge accumulation regions. In addition, DZ1 indicates a range of the zone Z1, DZ2 indicates a range of the zone Z2, DZ3 indicates a range of the zone Z3, and DMAX indicates a measurable range. In addition, TP indicates the duration of the pulsed light LP, TR represents the TOF of the pulsed light LP corresponding to the measurement limit position, and TC represents the duration of one frame.

Additionally, to improve the S (signal)/N (noise) ratio of the detection signal, the charge accumulation processing is repeatedly executed over a plurality of frames for each subframe, thereby increasing the accumulated charge amount detected in each subframe.

At this time, as illustrated in the lower section of FIG. 2, the amount of light detected by the pixel circuit decreases in inverse proportion to the square of the distance from the distance measurement device, and thus the number of frames for the charge accumulation processing is set to be larger for a subframe corresponding to a farther distance measurement range.

Specifically, when X is an integer, the number of frames for the charge accumulation processing in the subframe SF1 corresponding to the zone Z1 is defined as 1X, the number of frames for the charge accumulation processing in the subframe SF2 corresponding to the zone Z2 is defined as 4X, and the number of frames for the charge accumulation processing in the subframe SF3 corresponding to the zone Z3 is defined as 9X.

As illustrated in FIG. 3, to acquire detection signals, first of all, for the subframe SF1 corresponding to the zone Z1, the charge accumulation processing is continuously executed on the 1X frames to acquire four detection signals. Then, the pixel circuit is reset, to discharge the charge accumulated in the pixel circuit.

Next, for the subframe SF2 corresponding to the zone Z2, the charge accumulation processing is continuously executed on the 4X frames to acquire four detection signals. Then, the pixel circuit is reset to discharge the charge accumulated in the pixel circuit.

Next, for the subframe SF3 corresponding to the zone Z3, the charge accumulation processing is continuously executed on the 9X frames to acquire four detection signals. Then, the pixel circuit is reset to discharge the charge accumulated in the pixel circuit.

As described above, the four detection signals are acquired in each of the subframes SF1 to SF3, and as illustrated in FIG. 3, phase calculation is performed between the charge accumulation regions adjacent to each other, thereby acquiring the TOF.

The phase calculation is a process of acquiring the TOF by identifying the detection timing of the signal corresponding to the pulsed light LP through comparison between the detection signals from the charge accumulation regions adjacent to each other, regarding in which charge accumulation region and to what extent the signal corresponding to the pulsed light LP is detected.

In the distance measurement device of Comparative Example, since the charge accumulation processing is continuously executed on a plurality of frames for each subframe, a temporal difference in measurement timing occurs among subframes. In addition, in the distance measurement device of Comparative Example, in order to make the levels of the detection signals of each subframe uniform, the number of frames for the charge accumulation processing is set to be larger for the subframe corresponding to a farther distance measurement range. Still, it is difficult to make the levels of the detection signals of each subframe completely uniform.

Therefore, in a case where the distance measurement device of Comparative Example performs the phase calculation between the charge accumulation regions across the subframes, since there is a difference in the detection timing and the detection signal level, the phase calculation for acquiring the TOF performed between the charge accumulation regions across the subframes may result in an error in the measurement result.

To solve such a problem, the control unit 13 of the present exemplary embodiment performs measurement in which the light source 11 generates the pulsed light LP, the charge accumulation processing is executed for a plurality of subframes each being a unit for performing the charge accumulation processing for sequentially accumulating charge in the first to sixth charge accumulation regions 22a to 22f within a set duration, and the first to sixth signal detection units 24a to 24f acquire the amounts of charge accumulated in the first to sixth charge accumulation regions 22a to 22f as first to sixth detection signals corresponding to the pulsed light LP.

Then, the control unit 13 executes identification processing of identifying the subframe in which the signal, of the first to sixth detection signals, corresponding to the pulsed light LP is generated, and calculates the distance from the distance measurement device 1 to the measurement target S using the result of the identification processing and the phase of the signal, of the first to sixth detection signals, corresponding to the pulsed light LP.

Note that “sequentially accumulating charge” means that charge is sequentially accumulated in each of the plurality of charge accumulation regions at different timings without an interval. Here, the order of the plurality of charge accumulation regions in which the charge is accumulated is not particularly limited, and any order may be adopted.

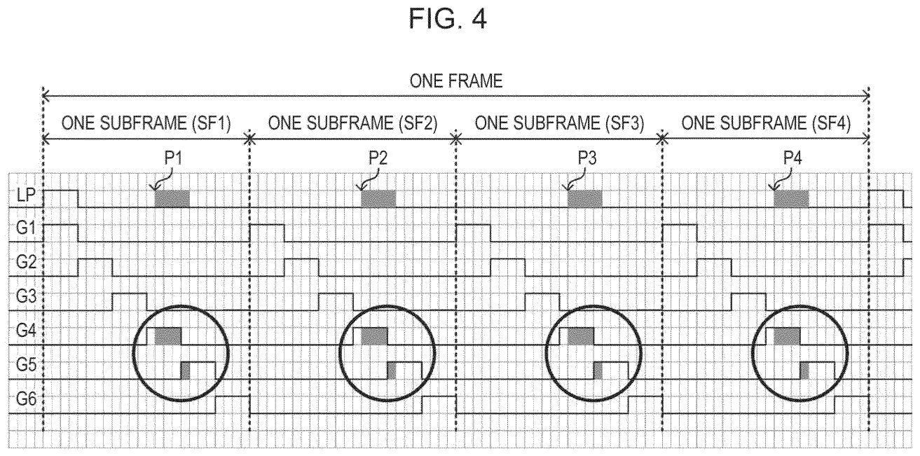

Hereinafter, the distance calculation processing in the distance measurement device 1 of the present exemplary embodiment will be described in detail. FIG. 4 is a diagram illustrating the distance calculation processing in the distance measurement device 1 of the present exemplary embodiment.

As illustrated in FIG. 4, for example, the control unit 13 divides one frame into four subframes SF1 to SF4, acquires first to sixth detection signals from the first to sixth charge accumulation regions 22a to 22f for each subframe, and acquires the TOF by performing phase calculation between the charge accumulation regions using the detection signals from the charge accumulation regions adjacent to each other. In this case, the distance measurement device 1 adopts a 6-tap/4-subframe-based system.

Unlike the distance measurement device of Comparative Example described above, the distance measurement device 1 of the present exemplary embodiment continuously and collectively performs detection in the four subframes SF1 to SF4 for one emission of the pulsed light LP.

However, in this case, in each of the plurality of subframes, the results of the phase calculation at the plurality of pulse positions with the same time from the start of the subframe are all the same. Thus, the pulse position, that is, the TOF cannot be uniquely determined from the result of the phase calculation. In the example in FIG. 4, the results of the phase calculation at the respective pulse positions P1 to P4 in the four subframes SF1 to SF4 are all the same.

Therefore, the control unit 13 executes the identification processing to identify the subframe in which the signal, of the first to sixth detection signals, corresponding to the pulsed light LP is generated, calculates the TOF by Formula (1) using the result of the identification processing and the phase of the signal, of the first to sixth detection signals, corresponding to the pulsed light LP, and calculates a distance DS from the distance measurement device 1 to the measurement target S by Formula (2) based on the calculated TOF.

$$TOF = ( n - 1 ) \cdot TSF + TP \qquad ( 1 )$$

$$DS = ( c \times T OF ) / 2 \qquad ( 2 )$$

where
TOF is time of flight of the pulsed light LP,
n is the order of the subframe in which the signal corresponding to the pulsed light LP is generated,
TSF is the time of one subframe,
TP is the time from the head of the subframe to the head position of the pulsed light LP,
DS is the distance from the distance measurement device 1 to the measurement target S, and
c is the speed of light.

Note that the identification processing for identifying the subframe in which the signal corresponding to the pulsed light LP has been generated is not particularly limited, and any method may be used.

For example, in a case where the shape of the measurement target S and the light reflectance of the surface of the measurement target S do not change and the incident position and the incident angle of the pulsed light LP with respect to the measurement target S are constant, the signal level of the detection signal corresponding to the pulsed light LP changes according to the distance between the distance measurement device 1 and the measurement target S.

In this case, in the identification processing, the control unit 13 may use the signal level of the detection signal corresponding to the pulsed light LP to identify the subframe in which the signal corresponding to the pulsed light LP is generated.

In detail, the range of the signal level of the detection signal may be set stepwise for the subframes in such a manner that the range of the signal level of the detection signal is set to be lower for the subframe corresponding to a zone farther from the distance measurement device 1, and the subframe in which the signal level of the detection signal corresponding to the pulsed light LP falls within a set range may be identified as the subframe in which the signal corresponding to the pulsed light LP is generated.

For example, in the case of performing the measurement on an unspecified measurement target S, the control unit 13 may perform first measurement in which charge is sequentially accumulated in a plurality of charge accumulation regions in each subframe within a first duration, and second measurement in which charge is sequentially accumulated in a plurality of charge accumulation regions in each subframe within a second duration different from the first time width, and in the identification processing, may identify the subframe in which the signal corresponding to the pulsed light LP is generated using the plurality of detection signals in the first measurement and the plurality of detection signals in the second measurement.

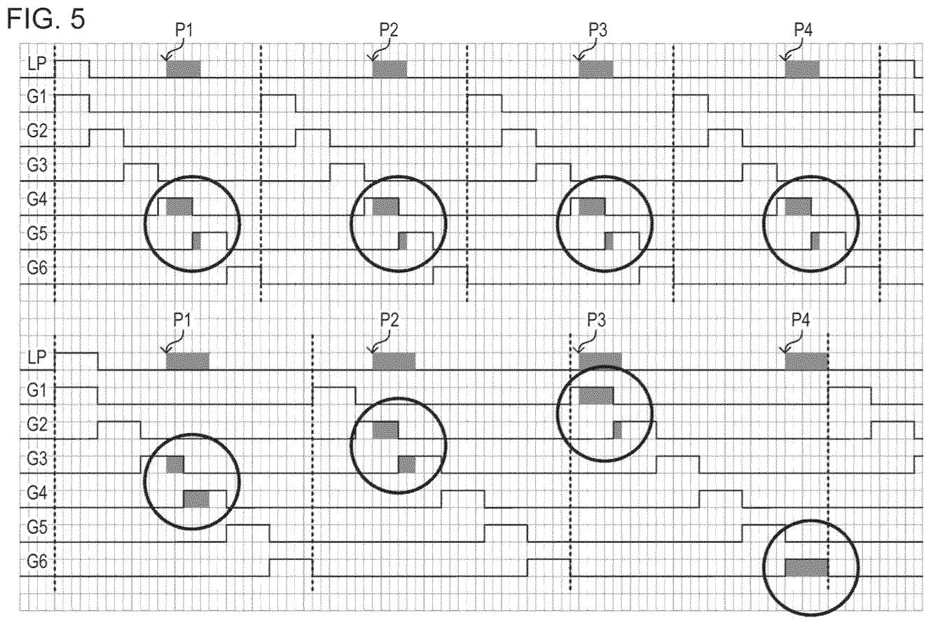

Thus, by performing two measurements with different durations for accumulating charge, as illustrated in FIG. 5, at a plurality of pulse positions where the results of the phase calculation in one measurement are all the same, the results of the phase calculation in the other measurement are all different.

Therefore, the subframe in which the signal corresponding to the pulsed light LP is generated can be identified by combining the results of two phase calculations in the two measurements with different durations for accumulating the charge.

In this case, the second measurement is an auxiliary measurement to identify the subframe in which the signal corresponding to the pulsed light LP is generated, and is not required to provide the same level of accuracy as the first measurement. Therefore, the control unit 13 may set the number of frames for the charge accumulation processing in the second measurement to be smaller than the number of frames for the charge accumulation processing in the first measurement.

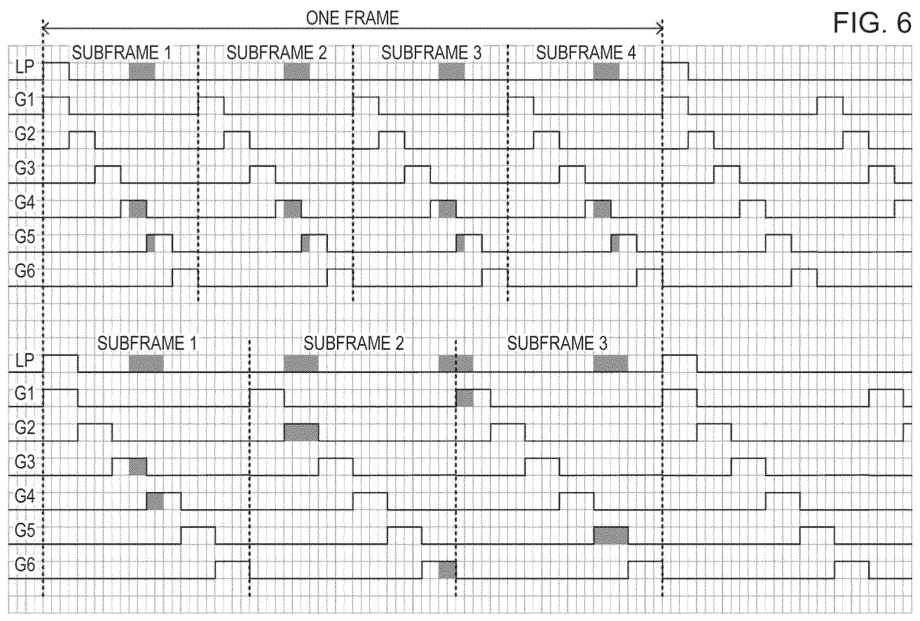

Furthermore, as illustrated in FIG. 6, the control unit 13 may define the ratio of the number of subframes in the first measurement to the number of subframes in the second measurement as b:a, where a is the first duration and b is the second duration.

In the example illustrated in FIG. 6, the first time width is set to 3 (a value for the ratio and thus has no unit), the second time width is set to 4 (a value for the ratio and thus has no unit), and the ratio between the number of subframes in the first measurement and the number of subframes in the second measurement is set to 4:3.

With such a configuration, the length of one frame in the first measurement can be the same as the length of one frame in the second measurement.

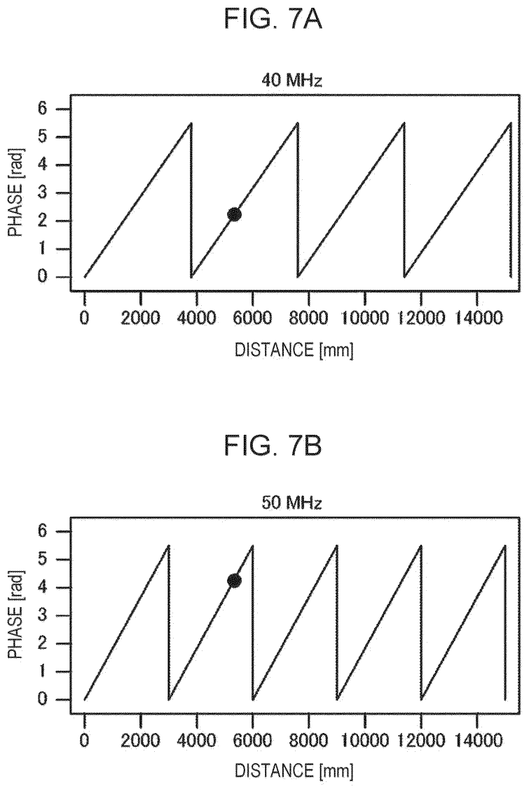

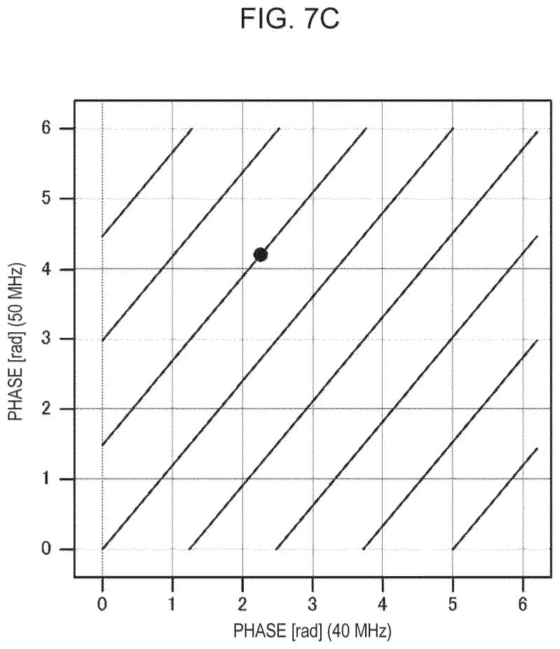

FIGS. 7A to 7C are diagrams illustrating a combination pattern of results of two phase calculations in a case where two measurements with different durations for accumulating charge is performed under a situation in which there is no multipath light between the distance measurement device 1 and the measurement target S. FIG. 7A is a graph illustrating a distance-phase relationship in a case where 40 MHz pulsed light is used. FIG. 7B is a graph illustrating a distance-phase relationship in a case where 50 MHz pulsed light is used. FIG. 7C is a graph illustrating a combination pattern of a phase in the case where 40 MHz pulsed light is used and a phase in the case where 50 MHz pulsed light is used.

In a case where two measurements with different durations for accumulating charge is performed as illustrated in FIGS. 7A and 7B under a situation in which there is no multipath light between the distance measurement device 1 and the measurement target S, a combination pattern of the result of the phase calculation by the plurality of detection signals in the first measurement and the result of the phase calculation by the plurality of detection signals in the second measurement converges to a predetermined pattern, as indicated by the black solid line in the graph in FIG. 7C.

Here, in a case where the combination pattern of the result of the phase calculation using the plurality of detection signals in the first measurement and the result of the phase calculation using the plurality of detection signals in the second measurement deviates from the predetermined pattern, it is expected that the measurement cannot be normally performed due to a factor such as generation of multi-path light between the distance measurement device 1 and the measurement target S.

Therefore, in the identification processing, the control unit 13 may issue an error notification when the combination pattern of the result of the phase calculation using the plurality of detection signals in the first measurement and the result of the phase calculation using the plurality of detection signals in the second measurement deviates from the combination pattern without the multipath light.

In addition, the control unit 13 may acquire a plurality of detection signals in each of a plurality of states different from each other in the number of frames for the charge accumulation processing in one measurement, and may calculate the distance using the plurality of detection signals acquired in a state, among the plurality of states, in which the highest signal value of the plurality of detection signals in the states is the maximum signal value not exceeding the set upper limit value.

Note that as described above, in a case of combining results of two phase calculations in two measurements with different durations for charge accumulation, the results of two phase calculations based on detection signals in a state in which the number of frames for the charge accumulation processing is the same in the two measurements may be combined.

In this case, when acquiring a plurality of detection signals in a plurality of states different from each other in the number of frames for the charge accumulation processing in one measurement, the control unit 13 may continuously execute the charge accumulation processing without discharging charge for each state.

### [Modifications]

While the distance measurement device according to an exemplary embodiment of the present disclosure has been described above, the technique of the present disclosure is not limited to the above-described exemplary embodiment and can be appropriately modified.

In the above exemplary embodiments, the processor refers to a processor in a broad sense, and includes a general-purpose processor (such as, for example, a central processing unit (CPU)) and a dedicated processor (such as, for example, a graphics processing unit (GPU), an application specific integrated circuit (ASIC), a field programmable gate array (FPGA), or a programmable logic device).

The operation of the processor in the above-described exemplary embodiments may be performed not only by one processor but also by a plurality of processors located at physically separated positions and cooperating with each other. Furthermore, the order of the operations of the processor is not limited to the order described in the above-described exemplary embodiments only, and may be appropriately changed.

### APPENDIX

(((1)))

A distance measurement device comprising:
a light source configured to irradiate a measurement target with pulsed light;
a pixel circuit that includes a photoelectric conversion region in which light that is the pulsed light reflected from the measurement target, is converted into charge and a plurality of charge accumulation regions in which the charge converted in the photoelectric conversion region is accumulated;
a signal detection unit configured to read, as a plurality of detection signals, signals corresponding to amounts of the charge accumulated in the plurality of respective charge accumulation regions; and
a processor configured to:
   control the light source, the pixel circuit, and the signal detection unit and calculate a distance using the plurality of detection signals, wherein
the processor is configured to:
   perform measurement in which the light source generates the pulsed light and charge accumulation processing is executed for a plurality of subframes each being a unit for performing the charge accumulation processing for sequentially accumulating charge in the plurality of charge accumulation regions within a set duration, and the signal detection unit acquires amounts of the charges accumulated in the plurality of charge accumulation regions as the plurality of detection signals for the pulsed light;
   execute identification processing of identifying a subframe in which a signal, of the plurality of detection signals, corresponding to the pulsed light is generated; and
   calculate a distance to the measurement target using a result of the identification processing and a phase of the signal, of the plurality of detection signals, corresponding to the pulsed light.
      (((2)))

The distance measurement device according to (((1))), wherein the processor is configured to identify the subframe in which the signal corresponding to the pulsed light is generated using a signal level of the signal corresponding to the pulsed light in the identification processing.

(((3)))

The distance measurement device according to (((1))), wherein the processor is configured to perform first measurement in which the charge is sequentially accumulated in the plurality of charge accumulation regions in each subframe within a first duration, and second measurement in which the charge is sequentially accumulated in the plurality of charge accumulation regions in each subframe within a second duration different from the first duration, and in the identification processing, configured to identify the subframe in which the signal corresponding to the pulsed light is generated using the plurality of detection signals in the first measurement and the plurality of detection signals in the second measurement.

(((4)))

The distance measurement device according to (((3))), wherein the processor is configured to set the number of frames for the charge accumulation processing in the second measurement to be smaller than the number of frames for the charge accumulation processing in the first measurement.

(((5)))

The distance measurement device according to (((3))) or (((4))), wherein the processor is configured to set a ratio between the number of subframes in the first measurement and the number of subframes in the second measurement to b:a, where a is the first duration and b is the second duration.

(((6)))

The distance measurement device according to any one of (((3))) to (((5))), wherein in the identification processing, the processor is configured to issue a notification of an error when a combination pattern of a result of phase calculation using the plurality of detection signals in the first measurement and a result of phase calculation using the plurality of detection signals in the second measurement deviates from a combination pattern in a case where there is no multipath light.

(((7)))

The distance measurement device according to any one of (((1))) to (((6))), wherein the processor is configured to acquire the plurality of detection signals in each of a plurality of states different from each other in the number of frames for the charge accumulation processing in one measurement, and calculate the distance using the plurality of detection signals acquired in a state, among the plurality of states, in which a highest signal value of the plurality of detection signals in the states is a maximum signal value not exceeding a set upper limit value.

(((8)))

The distance measurement device according to (((7))), wherein when acquiring the plurality of detection signals in the plurality of states different from each other in the number of frames for the charge accumulation processing in one measurement, the processor is configured to continue the charge accumulation processing without discharging the charge in each of the states.

(((9)))

A program executing a process for distance measurement using a distance measurement device including:
a light source configured to irradiate a measurement target with pulsed light;
a pixel circuit that includes a photoelectric conversion region in which light is converted into charge and a plurality of charge accumulation regions in which the charge converted in the photoelectric conversion region are accumulated; and
a signal detection unit configured to read, as a plurality of detection signals, signals corresponding to amounts of the charge accumulated in the plurality of respective charge accumulation regions,
the process comprising:
   performing measurement in which the light source generates the pulsed light and charge accumulation processing is executed for a plurality of subframes each being a unit for performing the charge accumulation processing for sequentially accumulating charge in the plurality of charge accumulation regions within a set duration, and the signal detection unit acquires amounts of the charge accumulated in the plurality of charge accumulation regions as the plurality of detection signals for the pulsed light;
   executing identification processing of identifying a subframe in which a signal, of the plurality of detection signals, corresponding to the pulsed light is generated; and
   calculating a distance to the measurement target using a result of the identification processing and a phase of the signal, of the plurality of detection signals, corresponding to the pulsed light.

What is claimed is:

1. A distance measurement device comprising:
a light source configured to irradiate a measurement target with pulsed light;
a pixel circuit that includes a photoelectric conversion region in which light that is the pulsed light reflected from the measurement target, is converted into charge and a plurality of charge accumulation regions in which the charge converted in the photoelectric conversion region is accumulated;
a signal detection unit configured to read, as a plurality of detection signals, signals corresponding to amounts of the charge accumulated in the plurality of respective charge accumulation regions; and
a processor configured to:
control the light source, the pixel circuit, and the signal detection unit and calculate a distance using the plurality of detection signals, wherein
the processor is configured to:
perform measurement in which the light source generates the pulsed light and charge accumulation processing is executed for a plurality of subframes each being a unit for performing the charge accumulation processing for sequentially accumulating charge in the plurality of charge accumulation regions within a set duration, and the signal detection unit acquires amounts of the charges accumulated in the plurality of charge accumulation regions as the plurality of detection signals for the pulsed light;
execute identification processing of identifying a subframe in which a signal, of the plurality of detection signals, corresponding to the pulsed light is generated; and
calculate a distance to the measurement target using a result of the identification processing and a phase of the signal, of the plurality of detection signals, corresponding to the pulsed light.

2. The distance measurement device according to claim 1, wherein the processor is configured to identify the subframe in which the signal corresponding to the pulsed light is generated using a signal level of the signal corresponding to the pulsed light in the identification processing.

3. The distance measurement device according to claim 1, wherein the processor is configured to perform:
first measurement in which the charge is sequentially accumulated in the plurality of charge accumulation regions in each subframe within a first duration, and
second measurement in which the charge is sequentially accumulated in the plurality of charge accumulation regions in each subframe within a second duration different from the first duration; and
in the identification processing, identify the subframe in which the signal corresponding to the pulsed light is generated using the plurality of detection signals in the first measurement and the plurality of detection signals in the second measurement.

4. The distance measurement device according to claim 3, wherein the processor is configured to set the number of frames for the charge accumulation processing in the second measurement to be smaller than the number of frames for the charge accumulation processing in the first measurement.

5. The distance measurement device according to claim 3, wherein the processor is configured to set a ratio between the number of subframes in the first measurement and the number of subframes in the second measurement to b:a, where a is the first duration and b is the second duration.

6. The distance measurement device according to claim 3, wherein in the identification processing, the processor is configured to issue a notification of an error when a combination pattern of a result of phase calculation using the plurality of detection signals in the first measurement and a result of phase calculation using the plurality of detection signals in the second measurement deviates from a combination pattern in a case where there is no multipath light.

7. The distance measurement device according to claim 1, wherein the processor is configured to acquire the plurality of detection signals in each of a plurality of states different from each other in the number of frames for the charge accumulation processing in one measurement, and calculate the distance using the plurality of detection signals acquired in a state, among the plurality of states, in which a highest signal value of the plurality of detection signals in the states is a maximum signal value not exceeding a set upper limit value.

8. The distance measurement device according to claim 7, wherein when acquiring the plurality of detection signals in the plurality of states different from each other in the number of frames for the charge accumulation processing in one measurement, the processor is configured to continue the charge accumulation processing without discharging the charge in each of the states.

9. A non-transitory computer readable medium storing a program executing a process for distance measurement using a distance measurement device including:
a light source configured to irradiate a measurement target with pulsed light;
a pixel circuit that includes a photoelectric conversion region in which light is converted into charge and a plurality of charge accumulation regions in which the charge converted in the photoelectric conversion region are accumulated; and
a signal detection unit configured to read, as a plurality of detection signals, signals corresponding to amounts of the charge accumulated in the plurality of respective charge accumulation regions,
the process comprising:
performing measurement in which the light source generates the pulsed light and charge accumulation processing is executed for a plurality of subframes each being a unit for performing the charge accumulation processing for sequentially accumulating charge in the plurality of charge accumulation regions within a set duration, and the signal detection unit acquires amounts of the charge accumulated in the plurality of charge accumulation regions as the plurality of detection signals for the pulsed light;
executing identification processing of identifying a subframe in which a signal, of the plurality of detection signals, corresponding to the pulsed light is generated; and
calculating a distance to the measurement target using a result of the identification processing and a phase of the signal, of the plurality of detection signals, corresponding to the pulsed light.
